(19) United States
(12) Patent Application Publication
(10) Pub. No.: US 2021/0383491 A1
(43) Pub. Date: Dec. 9, 2021

(54) PATENT TEXT GENERATING DEVICE, PATENT TEXT GENERATING METHOD, AND NON-TRANSITORY COMPUTER-READABLE MEDIUM

(71) Applicant: Al Samurai Inc., Tokyo (JP)

(72) Inventor: Takashi MIKAMI, Tokyo (JP)

(73) Assignee: Al Samurai Inc., Tokyo (JP)

(21) Appl. No.: 17/412,575

(22) Filed: Aug. 26, 2021

Related U.S. Application Data
(63) Continuation of application No. PCT/JP2019/021887, filed on May 31, 2019.

(51) Int. Cl. G06Q 50/18; G06N 20/00; G06F 40/166

(52) U.S. Cl. CPC G06Q 50/184; G06F 40/166; G06N 20/00

(57) ABSTRACT

A patent text generating device including a processor, and a memory including computer program code, the memory and the computer program code are configured to, with the processor, cause the patent text generating device to at least learn a plurality of correlations between a first claim of a patent document, a first description of the patent document, and a second description of a first prior art document to obtain a learning result, the first description being different from the first claim, and the first prior art document being correlated with the patent document, determine a patentability of a new claim, and generate text corresponding to a new claim based on the learning result and the new claim in response to determining the patentability of the new claim is equal to or greater than a level, the text being different from the new claim.

### CROSS-REFERENCE TO RELATED APPLICATIONS

This U.S. non-provisional application is a continuation of, and claims the benefit of priority under 35 U.S.C. § 365(c) from International Patent Application No. PCT/JP2019/021887 filed on May 31, 2019 in the World Intellectual Property Organization (WIPO), the contents of which are incorporated herein in by reference in their entirety.

### BACKGROUND

### Technical Field

Some example embodiments relate to a patent text generating device, a patent text generating method, and/or a non-transitory computer-readable medium.

### Description of Related Art

A specification for an application is essential for filing an application for a patent. A specification for a patent application includes challenges in the Background Art, Description which provides a detailed description of an invention, and Claims which correspond to the scope of a patent.

Patentability of a patent is effected by, for example, novelty and inventive step. Novelty is determined on the basis of whether the corresponding invention was known at the time of filing an application for the patent. Inventive step is determined on the basis of whether those skilled in the art could easily make the invention on the basis of techniques which were known at the time of filing an application for the patent.

Determination for inventive step is not easy. Accordingly, when the determination is remarkably difficult, a trial may be brought. One reason determination for inventive step is difficult is that inventive step is determined in consideration of relevance to the technical field or the background art in addition to the claims. Accordingly, a specification for a patent application is generally generated with human labor.

On the other hand, a system that automatically generates a patent document has been proposed. In one such system, items used to generate a patent document are received, are compared with prior art documents extracted by the system, and differences therebetween are generated as a specification for a patent application. Specifically, this system is configured to generate a specification for a patent application by replacing the differences with the extracted prior art documents.

### SUMMARY

However, since the system discussed above automatically extracts one or more prior art documents similar to a claim input by a user and generates a specification for a patent application on the basis of the one or more prior art documents, there is a likelihood that the quality of the generated specification for a patent application will be uneven due to the smaller number of prior art documents which are used as references. That is, contents of the specification for a patent application depend on descriptions of the extracted prior art documents.

Therefore, some example embodiments provide a patent text generating device, a patent text generating method, and/or a non-transitory computer-readable medium storing a patent text generating program that, when executed by a computer, may keep the quality of a generated specification for a patent application constant, and/or improve the quality of the generated specification, in consideration of the aforementioned challenges.

(1) According to some example embodiments, there is provided a patent text generating device including: at least one processor, and at least one memory including computer program code, wherein the at least one memory and the computer program code are configured to, with the at least one processor, cause the patent text generating device to at least learn a plurality of correlations between a first claim of a patent document, a first description of the patent document, and a second description of a first prior art document to obtain a learning result, the first description being different from the first claim, and the first prior art document being correlated with the patent document, determine a patentability of a new claim, and generate text corresponding to a new claim based on the learning result and the new claim in response to determining the patentability of the new claim is equal to or greater than a level, the text being different from the new claim.

(2) In the patent text generating device according to the configuration of (1) the at least one memory and the computer program code may be configured to, with the at least one processor, cause the patent text generating device to at least calculate a first conceptual distance between the first claim and the second description, and learn the plurality of correlations by correlating the first conceptual distance with the first claim or the second description.

(3) In the patent text generating device according to the configuration of (2), the at least one memory and the computer program code may be configured to, with the at least one processor, cause the patent text generating device to at least calculate a second conceptual distance between the new claim and a third description of a second prior art document, the second prior art document corresponding to the new claim, and generate the text based on the learning result and the second conceptual distance.

(4) In the patent text generating device according to any one of the configurations of (1) to (3), the at least one memory and the computer program code may be configured to, with the at least one processor, cause the patent text generating device to at least learn the plurality of correlations including learning a correlation between the first claim and a plurality of short text pieces to obtain the learning result, the plurality of short text pieces being obtained by dividing the first description into a plurality of entries, and the learning result corresponding to each of the plurality of short text pieces.

(5) In the patent text generating device according to any one of the configurations of (1) to (4), the at least one memory and the computer program code may be configured to, with the at least one processor, cause the patent text generating device to at least learn the plurality of correlations for each of a plurality of technical fields.

(6) In the patent text generating device according to any one of the configurations of (1) to (5), the at least one memory and the computer program code may be configured to, with the at least one processor, cause the patent text generating device to at least generate the text based on the first description.

(7) In the patent text generating device according to any one of the configurations of (1) to (5), the at least one memory and the computer program code may be configured to, with the at least one processor, cause the patent text generating device to at least generate the text based on the first description and the second description.

(8) In the patent text generating device according to any one of the configurations of (1) to (7) the at least one memory and the computer program code may be configured to, with the at least one processor, cause the patent text generating device to at least generate a specification of a patent application based on the text, generate a signal corresponding to the specification, and/or transmit the signal to an external device.

(9) According to some example embodiments, there is provided a patent text generating method which is performed by a computer, the patent text generating method including: learning a plurality of correlations between a first claim of a patent document, a first description of the patent document, and a second description of a prior art document to obtain a learning result, first description being different from the first claim, and the prior art document being correlated with the patent document, and generating text corresponding to a new claim based on the learning result and the new claim, the text being different from the new claim.

(10) According to some example embodiments, there is provided a non-transitory computer-readable medium storing a patent text generating program that, when executed by a computer, causes a device including the computer to learn a plurality of correlations between a first claim of a patent document, a first description of the patent document, and a second description of a prior art document to obtain a learning result, the first description being different from the first claim, and the second description being correlated with the patent document, and generate text corresponding to a new claim based on the learning result and the new claim, the text being different from the new claim.

According to some example embodiments, it is possible to provide a patent text generating device, a patent text generating method, and/or a non-transitory computer-readable medium storing a patent text generating program that, when executed by a computer, may keep the quality of a generated specification for a patent application constant, or improve the quality of the generated specification.

### BRIEF DESCRIPTION OF THE DRAWINGS

FIG. 1 is a diagram schematically illustrating an example of a routine which is performed by a patent text generating system 1 according to some example embodiments.

FIG. 2 is a diagram schematically illustrating an example of a configuration of the patent text generating system 1 according to some example embodiments.

FIG. 3 is a diagram schematically illustrating an example of a configuration of a user terminal device 2 according to some example embodiments.

FIG. 4 is a diagram schematically illustrating an example of a configuration of a server 4 according to some example embodiments.

FIG. 5 is a diagram illustrating an example of an operation sequence of a flow of control in learning a patent document by the patent text generating system 1 according to some example embodiments.

FIG. 6 is a diagram illustrating an example of an operation sequence of a flow of control in generating a specification for a patent application by the patent text generating system 1 according to some example embodiments.

### DETAILED DESCRIPTION

Hereinafter, a patent text generating device, a patent text generating method, and/or a non-transitory computer-readable medium according to some example embodiments of the present disclosure will be described with reference to the accompanying drawings. The technical scope of the present disclosure is not limited to some example embodiments and reaches the scope provided by the appended claims and equivalents thereto.

### Summary of Routine which is Performed by Patent Text Generating System 1

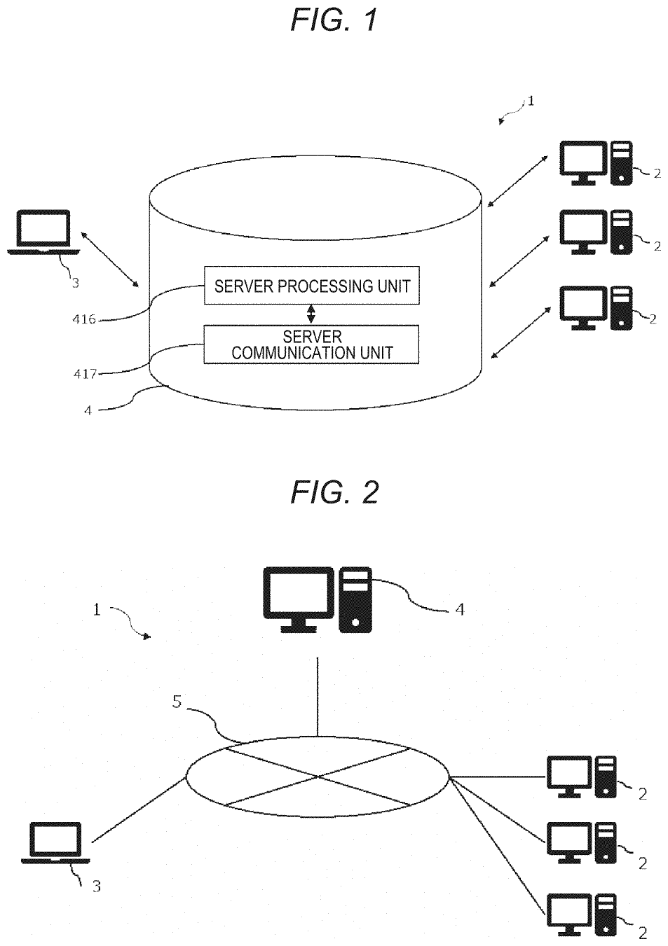

FIG. 1 is a diagram schematically illustrating an example of a routine which is performed by a patent text generating system 1 according to some example embodiments.

The patent text generating system 1 may include a plurality of user terminal devices 2, a patent document database 3, and/or a server 4 that communicates with the plurality of user terminal devices 2 and the patent document database 3. A server communication unit 417 of the server 4 receives a new claim which is subject matter of an invention for which a user wants to automatically generate a specification for a patent application from the plurality of user terminal devices 2, and a server processing unit 416 presents a specification for a patent application which is generated on the basis of the received new claim and training information of patent documents stored in the patent document database 3 to the user terminal devices 2. The server processing unit 416 of the server 4 may determine whether subject matter of the new claim received from the user has patentability, and automatically generate a specification for a patent application on the basis of the new claim received from the user and training information of the patent documents stored in the patent document database 3 when the determination result of patentability is equal to or greater than a predetermined or alternatively, given value.

Here, the patent text generating system 1 may be used to generate general patent text of reports for patented inventions in a company in addition to a specification for a patent application. That is, the usage of the patent text generating system is not limited to the description of this example as long as it is a document for summarizing differences from a prior art which is the related art. In this example, it is assumed that the patent text generating system 1 generates a specification for a patent application as patent text.

In the patent document database 3, only patent documents are used as prior art documents which are to be learned, but this database may be a database in which documents other than (e.g., different from) patent documents such as treatises are stored in addition to patent documents. That is, when correlations between subject matter of an invention, a description other than (e.g., different from) the subject matter of the invention, and a description of a prior art document correlated with the subject matter of the invention are stored, types of the documents stored in the patent document database 3 are not limited to the description of this example. In some example embodiments, a configuration in which the patent document database 3 stores patent documents is described as an example.

In some example embodiments, patent documents stored in the patent document database 3 are described as being retrieved, but the server 4 may employ a configuration in which patent documents are downloaded from the patent document database 3 and a plurality of similar patent documents are extracted in the server 4. With this configuration, since processing may be completed locally, it is possible to enhance a processing speed.

The patent document database 3 is, for example, a database of a Patent Office. The database of the Patent Office may include a database of a single Patent Office or databases of two or more Patent Offices. Since about 90% of patents of the world may be covered by including the databases of the five Patent Offices of the US, Europe, Japan, China, and Korea, the databases of the five Patent Offices may be included to enhance the determination accuracy of patentability.

### Schematic Configuration of Patent Text Generating System 1

FIG. 2 is a diagram schematically illustrating an example of a configuration of the patent text generating system 1 according to some example embodiments.

The patent text generating system 1, according to some example embodiments, includes a plurality of user terminal devices 2, a patent document database 3, and/or a server 4. In the following description, the plurality of user terminal devices 2 may be simply referred to as a user terminal device 2. The user terminal devices 2 and the server 4 may be connected to each other, for example, via a communication network such as the Internet 5.

The patent document database 3 and the server 4 may be connected to each other, for example, via a communication network such as the Internet 5. Only one Internet 5 is exemplified herein, but when the Internet 5 includes a plurality of networks, a gateway (not illustrated) may be appropriately provided between the networks. A program which is executed by the user terminal device 2 (for example, a browser program) and a program which is executed by the server 4 (for example, a management program) may communicate with each other using a communication protocol such as the hypertext transfer protocol (HTTP).

Since information which is handled may be secret information, a communication environment of the Internet 5 for connection between the user terminal device 2 and the server 4, and connection between the patent document database 3 and the server 4, may be secure. By preparing dedicated lines, it is possible to enhance the security of the connection between the user terminal device 2 and the server 4, and the connection between the patent document database 3 and the server 4.

### Schematic Configuration of User Terminal Device 2

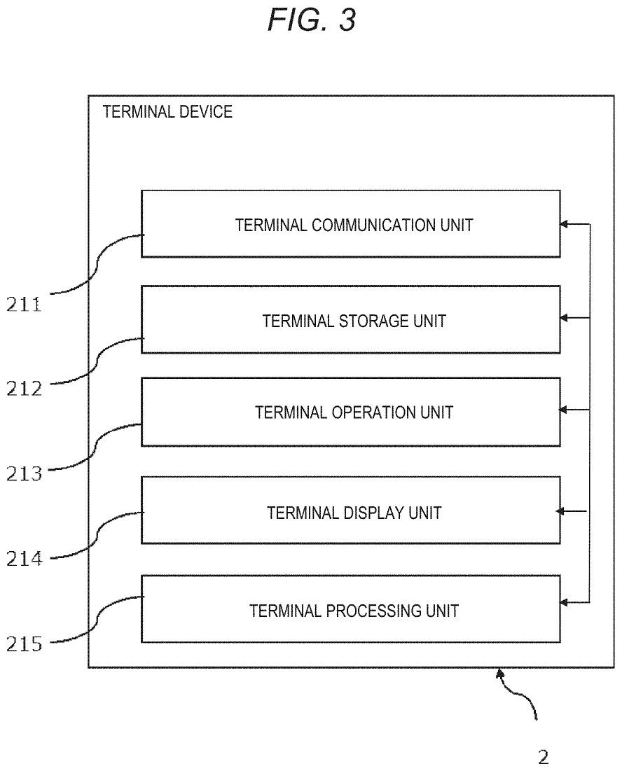

FIG. 3 is a diagram schematically illustrating an example of a configuration of a user terminal device 2 according to some example embodiments.

The user terminal device 2 may perform an access to a radio communication network, a web access, and/or the like. The user terminal device 2 may include a terminal communication interface or unit 211, a terminal storage device or unit 212, a terminal operation interface or unit 213, a terminal display or display unit 214, and/or a terminal processing device or unit 215.

A tablet personal computer (PC) or a notebook PC may be used as the user terminal device 2, but some example embodiments are not limited thereto. The user terminal device 2 may be any of, for example, a multifunction mobile phone (a so-called “smartphone”), a mobile phone (a so-called “feature phone”), a personal digital assistant (PDA), a portable game machine, a portable music player, and/or a tablet terminal as long as some example embodiments may be applied thereto.

The terminal communication unit 211 may include a communication interface circuit and connect the user terminal device 2 to the Internet 5. According to some example embodiments, the communication interface circuit may be an Ethernet interface, an 802.11 (WiFi) interface, a Radio Frequency (RF) (e.g., cellular) interface, a Transmission Control Protocol/Internet Protocol (TCP/IP) interface, a Universal Serial Bus (USB) interface, a Bluetooth™ interface, etc., or any combination thereof. The terminal communication unit 211 may transmit data supplied from the terminal processing unit 215 to the server 4 or the like via the network. The terminal communication unit 211 may supply data from the server 4 or the like via the network to the terminal processing unit 215.

The terminal storage unit 212 may include (or be implemented using), for example, a semiconductor memory device. According to some example embodiments, the semiconductor memory device may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art. The terminal storage unit 212 may store an operating system program, a driver program, an application program, data, and/or the like which may be used for processing in the terminal processing unit 215. For example, the terminal storage unit 212 may store an input device driver program that controls the terminal operation unit 213, an output device driver program that controls the terminal display unit 214, and/or the like as the driver program. These various programs may be installed in the terminal storage unit 212 from a computer-readable portable recording medium such as a CD-ROM, or a DVD-ROM, using a known setup program or the like. The terminal storage unit 212 may temporarily store temporary data associated with predetermined or alternatively, given processes.

The terminal operation unit 213 may be any device able to operate the user terminal device 2 and may be, for example, a mouse, a touch panel, a keyboard, and/or keys or buttons. A user may select or release information, or input characters, numerals, or the like, using the terminal operation unit 213. When the terminal operation unit 213 is operated by a user, the terminal operation unit 213 may generate a signal corresponding to the operation. The generated signal may be transmitted to the terminal processing unit 215.

The terminal display unit 214 may be any device able to display a video, an image, or the like and may be, for example, a liquid crystal display or an organic electroluminescence (EL) display. The terminal display unit 214 may display a video based on video data supplied from the terminal processing unit 215, an image based on image data supplied therefrom, or the like.

The terminal processing unit 215 include processing circuitry, for example, one or more processors and peripheral circuits thereof. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., or any combination thereof. The terminal processing unit 215 may comprehensively control the entire operation of the user terminal device 2 and may be, for example, a CPU. The terminal processing unit 215 may control the operation of the terminal communication unit 211, the terminal display unit 214, and/or the like such that various processes of the user terminal device 2 are performed in the appropriate order on the basis of a program stored in the terminal storage unit 212, the operation of the terminal operation unit 213, and/or the like. The terminal processing unit 215 may perform the processes on the basis of a program (the operating system program, the driver program, the application program, and/or the like) stored in the terminal storage unit 212, and thereby transform the terminal processing unit 215 into a special purpose processor specially programmed to provide the functionality embodied by the program. The terminal processing unit 215 may execute a plurality of programs (the application program and/or the like) in parallel.

The terminal processing unit 215 may have a function of processing screen display information received from the outside of the user terminal device 2 (e.g., an external source) as a screen display which may be browsed by a user, and a function of converting a process based on operation details of the terminal operation unit 213 by a user to a signal which may be transmitted to the outside of the user terminal device 2 and sending the converted signal to the terminal communication unit 211. These functions may correspond to functional modules which may be realized by a program executed by a processor of the terminal processing unit 215. Alternatively, the functional units may be mounted in the user terminal device 2 as independent integrated circuits, microprocessors, or firmware.

### Process of User Terminal Device 2

The user terminal device 2 may be operated by a user. The user may operate the terminal operation unit 213 to input a new claim with which a specification for a patent application is to be automatically generated to the user terminal device 2. According to some example embodiments, the terminal processing unit 215 may correct an error of a new claim or correct the grammar.

The user terminal device 2 may be a private terminal device for a user, or may be a terminal device for a company or a network of a company as a whole.

The terminal communication unit 211 of the user terminal device 2 may transmit a new claim input by a user to the server 4.

### Schematic Configuration of Patent Document Database 3

The patent document database 3 according to some example embodiments may provide a plurality of desired patent documents to the server 4 in response to a request from the server 4. That is, the patent document database 3 may extract patent documents corresponding to the request, on the basis of the request received from the server 4, and transmit the extracted patent documents to the server 4. The patent document database 3 may retrieve patent documents and transmit the retrieved patent documents to the server 4 when there is a request from the server 4, or the patent document database 3 may periodically transmit patents document to the server 4 on the basis of a representative result of retrieval. Although not particularly illustrated, the patent document database 3 may include, or may only include, a processing device or unit, a communication interface or unit, and/or a storage device or unit as elements of a server. According to some example embodiments, the processing unit of the patent document database 3 may be implemented using processing circuitry. According to some example embodiments, the communication unit of the patent document database 3 may be an Ethernet interface, a WiFi interface, an RF (e.g., cellular) interface, a TCP/IP interface, a USB interface, a Bluetooth™ interface, etc., or any combination thereof. According to some example embodiments, the storage unit of the patent document database 3 may be a tangible, non-transitory computer-readable medium, such as a RAM, a flash memory, a ROM, an EPROM, an EEPROM, registers, a hard disk, a removable disk, a CD ROM, any combination thereof, or any other form of storage medium known in the art.

When the server 4 also serves as the patent document database 3, the patent document database 3 may transmit a patent document to the server 4, and the server storage unit 411 or the like of the server 4 may store the patent document. The patent document database 3 may transmit a patent document to the server 4 in response to a request from the server 4 or may transmit a patent document to the server 4 by independent operation of the patent document database 3. In this case, since the server 4 may complete retrieval and determination within the server 4, it is possible to freely adjust a processing speed.

The patent document database 3 may cumulatively store unexamined patent publications and registered patent publications which are newly published. In the patent document database 3, all past patent documents may be itemized by, or only itemized by, entries. The patent document database 3 may store a plurality of short text pieces obtained by dividing each patent document into predetermined or alternatively, given entries. In this case, the server 4 may generate a specification for a patent application, which corresponds to a new claim and which is other than (e.g., different from) the new claim, for each entry corresponding to each of the plurality of short text pieces on the basis of results of learning for each predetermined or alternatively, given entry. For example, each patent document may be divided into ABSTRACT, WHAT IS CLAIMED (CLAIMS), and/or full text.

As described above, the patent document database 3 may be a database that stores technical papers or the like instead of, or in addition to, patent documents. In this case, the operation of the patent document database 3 may be the same as, or similar to, that when patent documents are stored.

### Schematic Configuration of Server 4

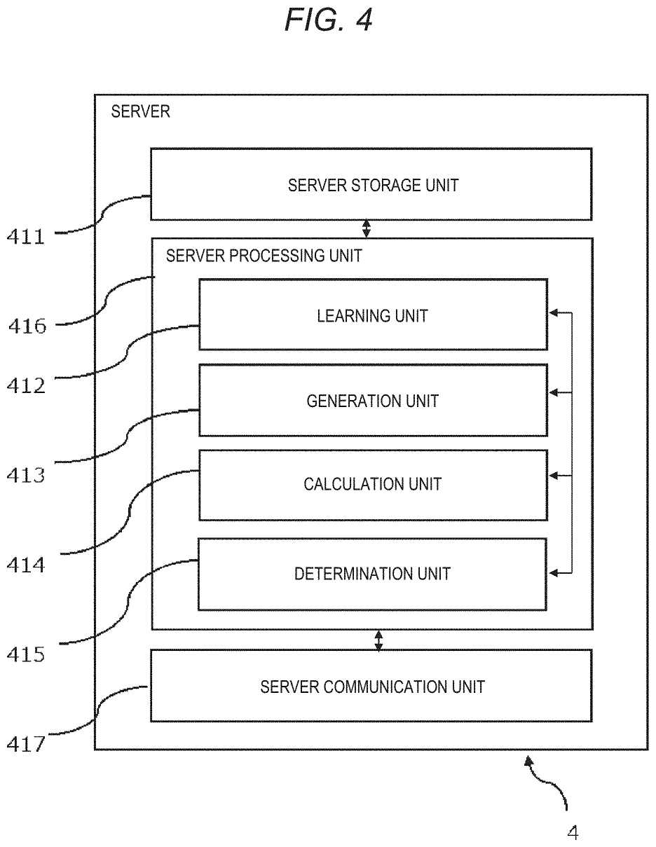

FIG. 4 is a diagram schematically illustrating an example of a configuration of the server 4 according to some example embodiments.

As illustrated in FIG. 4, the server 4 may include a server storage device or unit 411 which is a storage area of the server 4. The server 4 may further include a server processing device or unit 416 including a learning unit 412, a generation unit 413, a calculation unit 414, and/or a determination unit 415. According to some example embodiments, the server processing device 416, the learning unit 412, the generation unit 413, the calculation unit 414, and/or the determination unit 415 may be implemented using processing circuitry. The server 4 may further include a server communication unit 417 for communication with the user terminal device 2 and/or the patent document database 3.

The server 4 may include the server processing unit 416 including the learning unit 412 that may learn a plurality of patent documents received from the patent document database 3, the generation unit 413 that may generate a specification for a patent application corresponding to a new claim on the basis of the result of learning and the new claim, the calculation unit 414 that may calculate a first conceptual distance between a claim of a patent document and a description of a prior art document correlated with the patent document, and calculate a second conceptual distance between the new claim and a description of a prior art document corresponding to the new claim, and/or the determination unit 415 that may determine whether patentability of an input new claim is equal to or greater than a predetermined or alternatively, given value. The functional units of the server processing unit 416 may be functional modules which are realized by a program executed by a processor of the server processing unit 416, thereby transforming the server processing unit 416 into a special purpose processor specially programmed to provide the functionality embodied by the program. Alternatively, these functional units may be mounted in the server 4 as independent integrated circuits, microprocessors, and/or firmware. Process details of the server processing unit 416 will be described below. This partitioning of elements of the server processing unit 416 is only an example and an implementation by which a given element performs each process is not limited to the above description.

The server storage unit 411 may include (or be implemented by), for example, at least one of a semiconductor memory, a magnetic disk device, and/or an optical disc device, and may be connected to the server 4 (e.g., in implementations in which the server storage unit 411 is external to the server 4), or connected to the server processing unit 416 or the server communication unit 417, via a bus. According to some example embodiments, the server storage unit 411 may be a tangible, non-transitory computer-readable medium, such as a RAM, a flash memory, a ROM, an EPROM, an EEPROM, registers, a hard disk, a removable disk, a CD ROM, or any other form of storage medium known in the art. The server storage unit 411 may store a driver program, an operating system program, an application program, data, and/or the like which may be used for processing in the server processing unit 416. For example, the server storage unit 411 may store a communication device driver program that controls the server communication unit 417 as the driver program. These computer programs may be installed in the server storage unit 411 from a computer-readable portable recording medium such as a CD-ROM, or a DVD-ROM, using a known setup program or the like. The server storage unit 411 may store a result of learning from the learning unit 412.

The learning unit 412 may learn (e.g., determine) a plurality of correlations between a claim of a patent document, a description (other than, or different from, the claim) of the patent document, and/or a description of a prior art document correlated with the patent document (e.g., cited during prosecution of the patent document, having a similar subject matter to the patent document, etc.). Specifically, the learning unit 412 may learn by correlating results of morphological analysis of a plurality of patent documents received from the patent document database 3 with descriptions of prior art documents correlated with the patent documents similarly subjected to the morphological analysis. The learning unit 412 may learn by correlating results of morphological analysis of descriptions, other than (e.g., different from) claims of the patent documents, with a claim of another patent document.

Here, learning may include performing morphological analysis on a claim of a patent document or a description of a prior art document correlated with the patent document, dividing the patent document into words, giving (e.g., assigning) a vector (e.g., a local vector) to each word, and/or mapping each patent document to a multidimensional map for easy comparison between a plurality of patent documents (e.g., by repeating the morphological analysis, giving the vector, and mapping the patent document to the multidimensional map for the plurality of patent documents). Axes of the multidimensional map may be variously set and are not particularly limited to technical fields or challenges, types of technical features, the number of elements, the number of characters, and/or the like. Particularly, a distance (a vector including a direction) between mapping positions of a patent document and a prior art document correlated with the patent document may be learned as a first conceptual distance. The learning unit 412 may learn the mapping positions as a result of learning, or may additionally learn the first conceptual distance, which may be a distance between patent documents obtained as a result of calculation from the calculation unit 414, to be described further below as a result of learning. The learning method according to some example embodiments may not be limited to the aforementioned description and various learning methods may be employed.

The learning unit 412 may learn correlations (e.g., a plurality of correlations) between a plurality of short text pieces obtained by dividing a claim of a patent document and a description other than (e.g., different from) the claim of the patent document by predetermined or alternatively, given entries. This learning method may employ the aforementioned method. The generation unit 413 which will be described below may generate a specification for a patent application which corresponds to a new claim, and which is other than (e.g., different from) the new claim, for (e.g., based on) each entry corresponding to each of the plurality of short text pieces on the basis of the result of learning for each predetermined or alternatively, given entry. Here, entries of a patent document may represent (e.g., correspond to) ABSTRACT, WHAT IS CLAIMED IS (CLAIMS), full text, and/or the like (e.g., sections of a patent specification). According to some example embodiments, the learning unit 412 may learn the correlations by learning a correlation between a claim of a patent document and the plurality of short text pieces. The result of learning may correspond to each of the plurality of short text pieces.

The generation unit 413 may generate text which corresponds to a new claim, and which is other than (e.g., different from) the new claim, on the basis of the result of learning from the learning unit 412 and the new claim received by the server communication unit 417. The generation unit 413 may generate a specification for a patent application on the basis of the result of learning including the first conceptual distance and a second conceptual distance which will be described below. Here, in generating a specification for a patent application, the first conceptual distance and a second conceptual distance may be calculated using the same method or similar methods.

When the second conceptual distance is not calculated, the generation unit 413 may generate a specification for a patent application on the basis of the first conceptual distance and the mapping position of a new claim based on the aforementioned mapping method. In this case, the generation unit 413 may generate a specification for a patent application on the basis of information of the mapping position, which is separated an average first conceptual distance in the technical field of the new claim from the mapping position of the new claim, by substituting the result of morphological analysis of the new claim into the result of learning including the first conceptual distance. According to some example embodiments, the generation unit 413 may generate the specification based on a description (different from the claim(s)) of a respective patent document and/or a description of a prior art document correlated with the respective patent document, or may generate the specification based on the first conceptual distance that is calculated based on the respective patent document and/or the description of a prior art document correlated with the respective patent document.

The server 4 according to some example embodiments, may include at least, or may only include, a function of causing the learning unit 412 to learn a plurality of correlations between claims of patent documents, descriptions other than (e.g., different from) the claims of the patent documents, and/or descriptions of prior art documents correlated with the patent documents, causing the server communication unit 417 to receive a new claim, and/or causing the generation unit 413 to generate text which corresponds to the new claim and which is other than (e.g., different from) the new claim on the basis of the result of learning from the learning unit and the new claim received by the server communication unit 417. That is, the generation unit 413 may generate text which corresponds to the new claim, and which is other than the new claim, on the basis of the descriptions other than the claims of the patent documents. On the other hand, the generation unit 413 may generate text which corresponds to the new claim, and which is other than the new claim, on the basis of the descriptions other than the claims of the patent documents and the descriptions of the prior art documents correlated with the patent documents. Since the processing speed of the generation unit 413 changes depending on an amount of learning data which is used and the quality of generated patent text also depends on an amount of learning data which is used, a user or a provider of the server 4 may set (e.g., may appropriately set) an amount of learning data which is used. The generation unit 413 may generate text which corresponds to the new claim, and which is other than the new claim, by appropriately quoting (or paraphrasing) the descriptions of the patent documents which are learned by the learning unit 412.

The calculation unit 414 may calculate a first conceptual distance (vector) including a distance and a direction between the claims of the patent documents and the descriptions of the prior art documents correlated with the patent documents. Then, the learning unit 412 may learn by correlating the calculated first conceptual distance with the claims of the patent documents or the descriptions of the prior art documents correlated with the patent documents. The generation unit 413 may generate text which corresponds to the new claim, and which is other than the new claim, from the new claim on the basis of the result of learning from the learning unit 412. The conceptual distance may be, or may include, information indicating relationships in position information between the patent documents and the prior art documents which are subjected to morphological analysis. These relationships in position information are position information in a multidimensional space.

The calculation unit 414 may calculate a second conceptual distance between the new claim and a description of a prior art document corresponding to the new claim. Accordingly, the server communication unit 417 may also receive the description of the prior art document corresponding to the new claim. At least a part of the method of calculating the first conceptual distance may be used as the method of calculating the second conceptual distance. Then, the generation unit 413 may generate text which corresponds to the new claim, and which is other than (e.g., different from) the new claim, from the new claim on the basis of the result of learning from the learning unit 412 and the second conceptual distance. This conceptual distance may be, or may include, information representing relationships in position information between the patent documents and the prior art documents which are subjected to morphological analysis. When the calculation unit 414 calculates the first conceptual distance and the second conceptual distance using the same method (or similar methods), the generation unit 413 may generate a specification for a patent application by substituting the second conceptual distance into the result of learning including the first conceptual distance. That is, text which corresponds to the new claim, and which is other than (e.g., different from) the new claim, may be generated on the basis of information of a patent document which is present at a mapping position which is separated the second conceptual distance from a mapping position of the new claim in the multidimensional map.

The determination unit 415 may determine the patentability of the new claim received by the server communication unit 417. Specifically, the determination unit 415 may compare a result of calculation, which is a numerical value of the patentability of the new claim, with a predetermined (or alternatively, given) value (e.g., level) and determine that the new claim is patentable when the numerical value indicating the patentability is greater than the predetermined (or alternatively, given) value. The predetermined (or alternatively, given) value may be set to vary depending on the technical field or may be set to vary depending on the number of patent documents which are used for learning by the learning unit 412. Since the patentability decreases as the number of patent documents used by the learning unit 412 becomes greater, it is possible to enhance determination accuracy in the determination unit 415 by changing the predetermined (or alternatively, given) value.

For example, the determination unit 415 may calculate the numerical value indicating the patentability of the new claim by comparing the new claim with the claims of the prior art documents corresponding to the new claim. An existing text comparison technique may be used for comparison between text. In general, a numerical value indicating patentability may be calculated through comparison in appearance frequency between the same words (or similar words), comparison in appearance proportion between the same words (or similar words), and/or the like. Specifically, the determination unit 415 may extract a specific word out of words included in the new claim, retrieve synonyms or the like of the specific word from a database (not illustrated) in which synonyms, quasi-synonyms, or derivatives (such as synonyms) of a plurality of specific words are stored, and determine whether the meanings of text including synonyms or the like are similar. When the number of similar positions or a degree of similarity is small as the result of comparison, the determination unit 415 calculates the numerical value indicating patentability such that the numerical value decreases (or is lower). Alternatively, the determination unit 415 may calculate the numerical value indicating patentability through comparison in appearance frequency between words having the same concept (or similar concepts), comparison in appearance proportion between words having the same concept (or similar concepts), or the like using a concept dictionary. The determination unit 415 may perform the determination based on the ranking such as “Ranking S (very high),” “Ranking A (high),” “Ranking B (possible),” and “Ranking C (low)” depending on a patent right acquirability level.

The server communication unit 417 may include the communication interface circuit for connecting the server 4 to the Internet 5. According to some example embodiments, the communication interface circuit may be an Ethernet interface, a WiFi interface, an RF (e.g., cellular) interface, a TCP/IP interface, a USB interface, a Bluetooth™ interface, etc., or any combination thereof. The server communication unit 417 may receive a new claim of which generation of a specification for a patent application is requested by a user terminal device 2, and transmit a result of generation of the specification for a patent application from the generation unit 413 to the user terminal device 2. The server communication unit 417 may receive information when patent documents are supplied from the patent document database 3. The server communication unit 417 may perform various types of communication with the user terminal device 2 according to circumstances, and the server communication unit 417 may performs various types of communication with the patent document database 3 according to circumstances.

The server communication unit 417 may have two functions in some example embodiments. The first function is to receive a new claim from a user via a user terminal device 2. The second function is to additionally receive descriptions of prior art documents corresponding to the new claim via the user terminal device 2. The server communication unit 417 may also have a function of transmitting various types of information to the user terminal device 2. For example, the server communication unit 417 may transmit an entry form for allowing a user to input various types of information to the user terminal device 2 or transmit a specification for a patent application generated by the generation unit 413 to the user terminal device 2. The server communication unit 417 may correspond to, or be referred to as, a reception unit in the claims.

### Learning Process in Patent Text Generating System 1

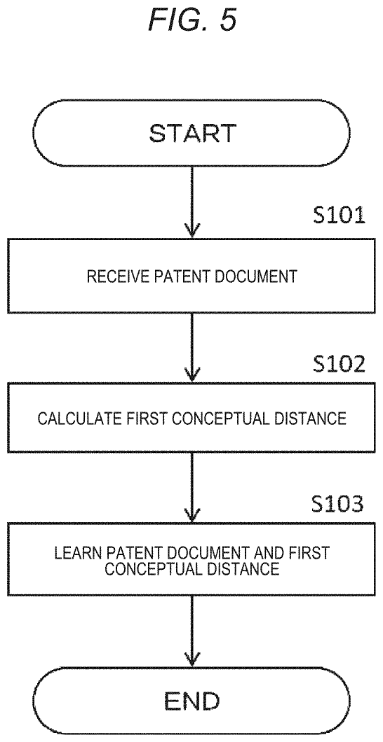

FIG. 5 is a diagram illustrating an example of an operation sequence of a flow of control in learning patent documents by the patent text generating system 1 according to some example embodiments.

The operation sequence which will be described below may be performed mainly (or entirely) by the server processing unit 416, for example, on the basis of a program stored in advance in the server storage unit 411 in cooperation with the constituents of the server 4. In the operation sequence which will be described below, the server 4 transmits and receives various types of information to and from the patent document database 3 via the server communication unit 417.

First, the server communication unit 417 of the server 4 may receive a patent document from the patent document database 3 (Operation S101). Although not particularly illustrated, the server 4 may transmit a request for transmission of a patent document from the server 4 to the patent document database 3 before Operation S101.

Subsequently, the server processing unit 416 may calculate a first conceptual distance between a claim of the patent document and a description of a prior art document correlated with the patent document (Operation S102). Operation S102 may be skipped and Operation S103 may be performed.

Then, the server processing unit 416 may learns by correlating the first conceptual distance calculated in Operation S102 with the claim of the patent document or the description of the prior art document correlated with the patent document (Operation S103). When Operation S102 is skipped, the server processing unit 416 may learn the claim of the patent document or the description of the prior art document correlated with the patent document in correlation. The server processing unit 416 may end the operation sequence after learning the patent document received from the patent document database 3.

### Process of Generating Specification for Patent Application in Patent Text Generating System 1

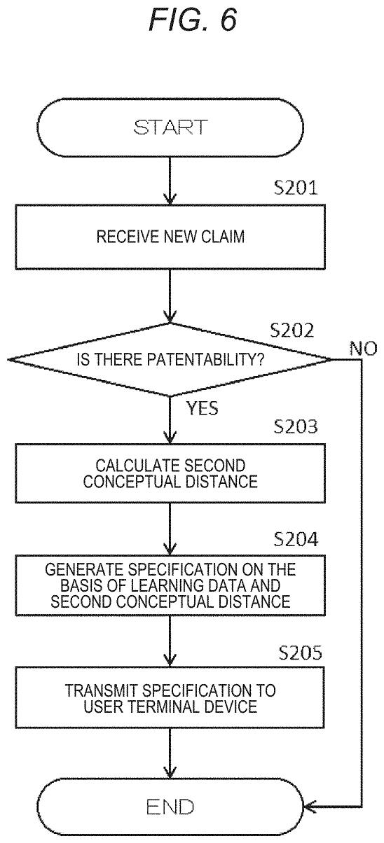

FIG. 6 is a diagram illustrating an example of an operation sequence of a flow for generating a specification for a patent application by the patent text generating system 1 according to some example embodiments.

The operation sequence which will be described below may be performed mainly (or entirely) by the server processing unit 416, for example, on the basis of a program stored in advance in the server storage unit 411 in cooperation with the constituents of the server 4. In the operation sequence which will be described below, the server 4 transmits and receives various types of information to and from the user terminal device 2 via the server communication unit 417.

First, the server processing unit 416 may receive a new claim from the user terminal device 2 (Operation S201). The claim may have a format which is described in a specification for a patent application or a format such as a memo in which subject matter of an invention is simply arranged. The server processing unit 416 may receive a prior art document, which serves as a basis for reaching the new claim, from the user terminal device 2 in addition to the new claim. In some example embodiments, in Operation S201, a prior art document which serves as a basis for reaching the new claim may not be received and only the new claim may be received.

The server processing unit 416 may determine whether the new claim received in Operation S201 has patentability (Operation S202). The server processing unit 416 may calculate a value indicating a patentability level of the new claim and determine whether the calculated patentability level is equal to or greater than a predetermined or alternatively, given value. Various existing techniques may be used to determine the patentability of the new claim.

When a prior art document is received, as discussed above, in Operation S201, the server processing unit 416 may calculate the value indicating a patentability level by comparing the prior art document and the new claim with each other.

When the server processing unit 416 determines that the value indicating the patentability level is equal to or greater than the predetermined or alternatively, given value in Operation S202 (YES in Operation S202), the server processing unit 416 may calculate the second conceptual distance from the prior art document, which serves as a basis for reaching the new claim, and the new claim (Operation S203). When a prior art document which serves as a basis for reaching the new claim is not received in Operation S201, Operation S203 may be skipped.

On the other hand, when the server processing unit 416 determines that the value indicating the patentability level is less than the predetermined or alternatively, given value in Operation S202 (NO in Operation S202), the server processing unit 416 may end the operation sequence.

The server processing unit 416 may generate a specification for a patent application on the basis of the result of learning described above with reference to FIG. 5 and the second conceptual distance (Operation S204) after the second conceptual distance has been calculated in Operation S203. The server processing unit 416 may accurately generate a specification for a patent application by calculating the first conceptual distance and the second conceptual distance using the same method or similar methods.

When Operation S203 is skipped and a specification for a patent application is generated from the first conceptual distance and the new claim, the server processing unit 416 may generate the specification for a patent application by substituting a result of morphological analysis of the new claim into the result of learning including the first conceptual distance. According to some example embodiments, the server processing unit 416 may generate the patent application including the specification.

Then, the server processing unit 416 may transmit the specification for a patent application (or the patent application including the specification) which has been automatically generated in Operation S204 to the user terminal device 2 (Operation S205). According to some example embodiments, the server processing unit 416 may generate a signal corresponding to the specification for the patent application (or the patent application including the specification) and transmit the signal to the user terminal device 2. According to some example embodiments, the user terminal device 2 may generate the patent application including the specification. The operation sequence may end when the process of Operation S205 has been completed.

As described above, the patent text generating system 1 according to some example embodiments may automatically generate a specification for a patent application corresponding to at least a new claim which is input to the user terminal device 2 on the basis of a result of learning of patent documents. Since many patent documents are learned as learning data by machine learning, it is possible to maintain the high quality (or increase the quality) of a specification for a patent application.

The patent text generating system 1 according to some example embodiments may calculate the second conceptual distance by receiving a prior art document, which serves as a basis for reaching the new claim, in addition to the new claim and generate a specification for a patent application with higher accuracy from a relationship with the first conceptual distance included in the result of learning.

Since the patent text generating system 1 according to some example embodiments determines patentability of a new claim and automatically generates a specification for a patent application only when the patentability is high, it is possible to prevent a specification for a patent application from being automatically generated on the basis of a new claim with low patentability, or reduce the occurrence thereof. The patentability is also determined through comparison with a program or a prior art. When a user transmits a prior art document which serves as a basis for reaching a new claim in addition to the new claim, the patentability is determined on the basis of the prior art document and thus it is possible to generate a specification for a patent application by determining patentability with higher accuracy.

Some example embodiments may be embodied as a patent text generating method including: a learning operation of learning a plurality of correlations between a claim of a patent document, a description other than the claim of the patent document, and a description of a prior art document correlated with the patent document; a reception operation of receiving a new claim; and a generation operation of generating text which corresponds to the new claim and which is other than the new claim on the basis of a result of learning in the learning operation and the new claim received in the reception operation.

Some example embodiments may be embodied as a non-transitory computer-readable medium storing a patent text generating program that, when executed by a computer, causes a device including the computer to perform: a learning function of learning a plurality of correlations between a claim of a patent document, a description other than the claim of the patent document, and a description of a prior art document correlated with the patent document; a reception function of receiving a new claim; and a generation function of generating text which corresponds to the new claim and which is other than the new claim on the basis of a result of learning from the learning function and the new claim received by the reception function.

Conventional devices for generating a patent specification compare patent documents with prior art documents similar to an input claim, and generate the patent specification by replacing differences between the patent and prior art documents with description from the prior art documents. However, the description from the prior art documents is insufficient (e.g., unclear, not relevant, inaccurate, etc.) because, for example, the number of prior art documents similar to the input claim is relatively small. Accordingly, the conventional devices generate patent specifications of insufficient quality.

However, according to some example embodiments, improved devices are provided for generating a patent specification. For example, the improved devices may learn a plurality of correlations between patent documents (e.g., reference patent documents) and prior art documents corresponding to the patent documents, and generate a patent specification based on a new claim using the plurality of correlations. The generated patent specification is clearer, more relevant, more accurate, etc., because the plurality of correlations are not limited to those based on prior art documents corresponding to the new claim. Accordingly, the improved devices overcome the deficiencies of the conventional devices to generate patent specifications of higher quality.

In some example embodiments, the processing circuitry may perform some operations (e.g., the operations described herein as being performed by the learning unit 412) by artificial intelligence and/or machine learning. As an example, the processing circuitry may implement an artificial neural network (e.g., the learning unit 412) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Those skilled in the art should understand that some example embodiments may be subjected to various modifications, substitutions, and corrections without departing the spirit and scope thereof.

### Modified Examples

The learning unit 412 has been described to learn a plurality of correlations between a claim of a respective patent document, a description other than the claim of the respective patent document, and descriptions of prior art documents correlated with the patent document, but this learning may be performed for each technical field (of a plurality of technical fields) to accumulate results of learning with high accuracy. For example, the learning unit 412 may accumulate a result of learning from patent documents by International Patent Classifications (IPCs), File Index (FI) terms (patent classifications in the Japan Patent Office), and/or the like.

What is claimed is:

1. A patent text generating device comprising:
at least one processor; and
at least one memory including computer program code,
wherein the at least one memory and the computer program code are configured to, with the at least one processor, cause the patent text generating device to at least,
learn a plurality of correlations between a first claim of a patent document, a first description of the patent document, and a second description of a first prior art document to obtain a learning result, the first description being different from the first claim, and the first prior art document being correlated with the patent document;
determine a patentability of a new claim; and
generate text corresponding to a new claim based on the learning result and the new claim in response to determining the patentability of the new claim is equal to or greater than a level, the text being different from the new claim.

2. The patent text generating device according to claim 1, wherein the at least one memory and the computer program code are configured to, with the at least one processor, cause the patent text generating device to at least:
calculate a first conceptual distance between the first claim and the second description; and
learn the plurality of correlations by correlating the first conceptual distance with the first claim or the second description.

3. The patent text generating device according to claim 2, wherein the at least one memory and the computer program code are configured to, with the at least one processor, cause the patent text generating device to at least:
calculate a second conceptual distance between the new claim and a third description of a second prior art document, the second prior art document corresponding to the new claim; and
generate the text based on the learning result and the second conceptual distance.

4. The patent text generating device according to claim 1, wherein the at least one memory and the computer program code are configured to, with the at least one processor, cause the patent text generating device to at least learn the plurality of correlations including learning a correlation between the first claim and a plurality of short text pieces to obtain the learning result, the plurality of short text pieces being obtained by dividing the first description into a plurality of entries, and the learning result corresponding to each of the plurality of short text pieces.

5. The patent text generating device according to claim 1, wherein the at least one memory and the computer program code are configured to, with the at least one processor, cause the patent text generating device to at least learn the plurality of correlations for each of a plurality of technical fields.

6. The patent text generating device according to claim 1, wherein the at least one memory and the computer program code are configured to, with the at least one processor, cause the patent text generating device to at least generate the text based on the first description.

7. The patent text generating device according to claim 1, wherein the at least one memory and the computer program code are configured to, with the at least one processor, cause the patent text generating device to at least generate the text based on the first description and the second description.

8. The patent text generating device according to claim 1, wherein the at least one memory and the computer program code are configured to, with the at least one processor, cause the patent text generating device to at least cause the patent text generating device to generate a specification of a patent application based on the text.

9. The patent text generating device according to claim 8, wherein the at least one memory and the computer program code are configured to, with the at least one processor, cause the patent text generating device to at least:
generate a signal corresponding to the specification; and
transmit the signal to an external device.

10. A patent text generating method performed by a computer, the patent text generating method comprising:
learning a plurality of correlations between a first claim of a patent document, a first description of the patent document, and a second description of a prior art document to obtain a learning result, first description being different from the first claim, and the prior art document being correlated with the patent document; and
generating text corresponding to a new claim based on the learning result and the new claim, the text being different from the new claim.

11. The patent text generating method according to claim 10, wherein the method further comprises:
generating a specification of a patent application based on the text;
generating a signal corresponding to the specification; and
transmitting the signal to an external source.

12. A non-transitory computer-readable medium storing a patent text generating program that, when executed by a computer, causes a device including the computer to:
learn a plurality of correlations between a first claim of a patent document, a first description of the patent document, and a second description of a prior art document to obtain a learning result, the first description being different from the first claim, and the second description being correlated with the patent document; and
generate text corresponding to a new claim based on the learning result and the new claim, the text being different from the new claim.

13. The non-transitory computer-readable medium according to claim 12, wherein the patent text generating program causes the device to:
calculate a first conceptual distance between the first claim and the second description; and
learn the plurality of correlations by correlating the first conceptual distance with the first claim or the second description.

14. The non-transitory computer-readable medium according to claim 13, wherein the patent text generating program causes the device to:
calculate a second conceptual distance between the new claim and a third description of a second prior art document, the second prior art document corresponding to the new claim; and
generate the text based on the learning result and the second conceptual distance.

15. The non-transitory computer-readable medium according to claim 12, wherein the patent text generating program causes the device to learn the plurality of correlations including learning a correlation between the first claim and a plurality of short text pieces to obtain the learning result, the plurality of short text pieces being obtained by dividing the first description into a plurality of entries, and the learning result corresponding to each of the plurality of short text pieces.

16. The non-transitory computer-readable medium according to claim 12, wherein the patent text generating program causes the device to learn the plurality of correlations for each of a plurality of technical fields.

17. The non-transitory computer-readable medium according to claim 12, wherein the patent text generating program causes the device to generate the text based on the first description.

18. The non-transitory computer-readable medium according to claim 12, wherein the patent text generating program causes the device to generate the text based on the first description and the second description.

19. The non-transitory computer-readable medium according to claim 12, wherein the patent text generating program causes the device to generate a specification of a patent application based on the text.

20. The non-transitory computer-readable medium according to claim 19, wherein the patent text generating program causes the device to:
generate a signal corresponding to the specification; and
transmit the signal to an external device.
